(19) United States
(12) Patent Application Publication
(10) Pub. No.: US 2002/0126734 A1
(43) Pub. Date: Sep. 12, 2002

(54) Soldering iron temperature measurement jig and methods of making and using the same

(75) Inventors: David Allen Murtishaw, Sun City, CA (US); Brian Michael Solomich, Vista, CA (US); Edward Martinez, Vista, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(73) Assignee: Sony Corporation

(21) Appl. No.: 09/800,626

(22) Filed: Mar. 7, 2001

(51) Int. Cl. G01K 7/04; G01K 1/14; G01K 13/00

(52) U.S. Cl. 374/179; 374/141

(57) ABSTRACT

A jig incorporates a thermocouple clamp for measuring the temperature of a soldering iron. With the jig and the thermocouple clamp, the method of taking the temperature of the soldering iron is made consistent. Consequently, any variations in temperature readings can be attributed to an actual change in soldering iron temperature and not to a variation in the technique for measuring the temperature. Thus, the temperature of the soldering iron can be controlled with high accuracy. This is important particularly in high-precision manufacturing processes.

### FIELD OF THE INVENTION

The present invention relates to the field of soldering, particularly in commercial manufacturing processes. More specifically, the present invention relates to a means for reliably and accurately measuring and controlling the temperature of a soldering iron so that the temperature is constantly maintained in the acceptable temperature range required for optimization of a sensitive soldering operation, particularly in a commercial production line.

### BACKGROUND OF THE INVENTION

Soldering is a process that is used to make electrical connections between parts of a circuit, usually on a circuit board. Soldering can also be used to secure circuit elements on a circuit board.

Soldering is performed by briefly heating a conductive metal alloy, known as solder, until it reaches a liquid state. Solder is often a lead tin alloy with a relatively low melting point that can be readily liquefied. The liquid metal can then be applied at the location where an electrical connection between circuit elements is needed, or where support for a circuit element is required. The liquid metal then cools and hardens to form the required connection or to secure the element to the circuit board.

Often a printed circuit board is used in which electrical lines or connections between circuit elements are printed on the board. Circuit elements are then soldered to the board. The solder holds the circuit elements on the printed circuit board and electrically connects the circuit elements to the printed electrical connections on the board.

Electrical circuits are included in a wide variety of commercial products, including television sets, computers, stereos, electronic toys, camcorders, digital cameras, etc. Circuits, both on and off a circuit board, in these and many other products may use soldering in assembling the circuit. Consequently, soldering is an important element in many commercial manufacturing processes.

Soldering is performed with an element known as a soldering iron. The soldering iron uses an electrical current to generate enough heat to liquefy the solder so that it can be applied where needed in its liquid state. A soldering iron can be made as a hand tool for use by a technician. A soldering iron can also be incorporated into the automated machinery of a manufacturing process.

Given the precision required by modem electronic devices, regulating the temperature of the soldering iron becomes very important. If the iron is too hot, the liquefied solder will take longer to solidify and may be disturbed before doing so, particularly in a commercial process. If the iron is too cold, the solder will take longer to liquefy or will solidify too quickly before it can be appropriately placed. The temperature of the soldering iron will vary with, for example, the ambient temperature, the current used to heat the iron, the temperature of the soldering being liquefied, etc.

In a manufacturing process, either automated or with a manual assembly line, it becomes important to maintain the temperature of the soldering iron within a particular range so that each time the soldering iron is used consistent results are obtained. Otherwise, the quality and character of products produced will tend to vary widely. This will not be satisfactory to consumers who want reliability and manufacturers who want consistent quality.

It is, of course, possible to provide technicians with equipment for measuring the temperature of a soldering iron. However, individual techniques for taking such measurements can vary widely and destroy the consistency desired. Additionally, each technician may take each measurement in a slightly different way further degrading any consistency in monitoring the soldering iron temperature. For example, if the measurements are each taken at different points on the soldering iron, this variation in technique will affect the reliability of the measurements and degrade the ability to regulate the soldering iron.

Consequently, there is a need in the art for a method and means of consistently and accurately measuring the temperature of a soldering iron so that the temperature can be regulated within an acceptable range to provide consistency, particularly in commercial manufacturing processes that require high-precision soldering.

### SUMMARY OF THE INVENTION

The present invention meets the above-described needs and others. Specifically, the present invention provides a method and means of consistently and accurately measuring the temperature of a soldering iron so that the temperature can be regulated within an acceptable range to provide consistency, particularly in commercial manufacturing processes that require high-precision soldering.

Additional advantages and novel features of the invention will be set forth in the description which follows or may be learned by those skilled in the art through reading these materials or practicing the invention. The advantages of the invention may be achieved through the means recited in the attached claims.

The present invention may be embodied and described as a jig for monitoring a temperature of a heated instrument. The jig includes a thermocouple clamp for attaching to the heated instrument to provide an indication of the temperature of the heated instrument; and a connection for providing output to a meter that determines the temperature of the heated instrument based on the output from the thermocouple clamp. A guide member of the jig is abutted or aligned with an element of the heated instrument so that the thermocouple clamp is placed at a consistent point on the heated instrument each time the jig is used.

In a preferred embodiment, the heated instrument is a soldering iron and the element of the heated instrument to which the guide member is abutted or aligned is the handle of the soldering iron. If the heated instrument is a soldering iron, the thermocouple clamp is sized and shaped to attach to the soldering iron.

The thermocouple clamp includes first and second opposed clamp jaws; and a bias element that urges the clamp jaws together so that the clamp jaws grip the heated instrument with a consistent force when the jig is applied to monitor the temperature of the heated instrument. Preferably, the first and second jaws extend into posts that are pivotally attached to the jig such that by moving the posts toward each other, the jaws can be moved apart against the bias element.

The jig of the present invention may be used in a system for monitoring the temperature of a heated instrument. The system includes the jig and a meter that is connected to and receives an output voltage from the thermocouple clamp of the jig. The meter determines the temperature of the heated instrument based on output from the thermocouple clamp.

In one preferred embodiment, the meter is associated with a processor which monitors the temperature of the heated instrument using the meter and automatically controls the temperature of the heated instrument in response to the output of the meter and in accordance with a predetermined operating temperature range. The microprocessor may be connected to a variable resistor for controlling electric current to the heated instrument, which heated instrument is heated by the electric current.

The present invention also encompasses the methods of making and using the jig and system described above. Specifically, the present invention encompasses a method for monitoring a temperature of a heated instrument by attaching a jig to the heated instrument using a thermocouple clamp supported on the jig, the thermocouple clamp outputting an indication of a temperature of the heated instrument; and determining the temperature of the heated instrument based on output from the thermocouple clamp to a meter that is connected to and receives an output voltage from the thermocouple clamp. The method of the present invention may also include automatically controlling a temperature of the heated instrument in response to output of the meter and in accordance with a predetermined operating temperature range.

Preferably, the method of the present invention also includes abutting or aligning a guide member of the jig with an element of the heated instrument so that the thermocouple clamp is placed at a consistent point on the heated instrument each time the jig is used. Additionally, attaching the jig to the heated instrument may include griping the heated instrument with the first and second clamp jaws of the thermocouple clamp. This is preferably done by moving posts toward each other to move apart the clamp jaws to receive the heated element, where the posts extend from the first and second jaws and are pivotally attached to the jig such that by moving the posts toward each other, the jaws can be moved apart against the bias element.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is an illustration of a first embodiment of a soldering iron temperature measurement jig according to the present invention.

FIG. 2 is a close-up illustration of the thermocouple clamp of the jig in FIG. I according to the present invention.

FIG. 3 is an illustration of a first embodiment of a soldering iron temperature jig according to the present invention.

Throughout the drawings, identical elements are designated by identical reference numbers.

### DETAILED DESCRIPTION OF THE PREFERRED EMBODIMENTS

The present invention provides a jig that incorporates a thermocouple clamp for measuring the temperature of a soldering iron. With the jig and the thermocouple clamp, the method of taking the temperature of the soldering iron is made consistent. Consequently, any variations in temperature readings can be truly attributed to an actual change in soldering iron temperature and not to a variation in the technique for measuring the temperature.

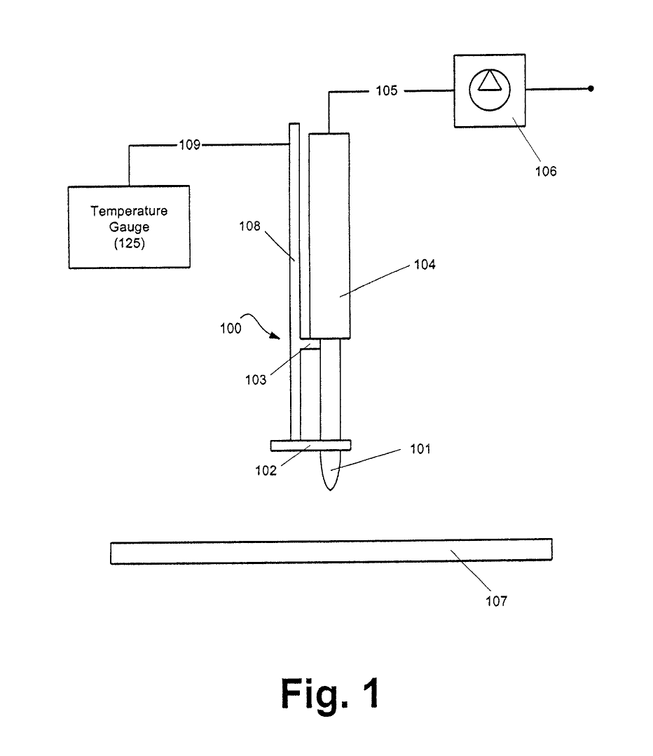

Using the drawings, the preferred embodiments of the present invention will now be explained. FIG. 1 illustrates a first preferred embodiment of the means and method for monitoring the temperature of a soldering iron according to the present invention. As shown in FIG. 1, a soldering iron (101) extends from a handle (104). The soldering iron (101) is used to heat and liquefy solder on a work-piece (107), for example, a printed circuit board.

Electrical current is supplied by a wire (105) to the soldering iron (101). The current is used to heat the iron (101) to temperatures that will melt solder when the soldering iron (101) is brought into physical contact with the solid solder. The temperature of the iron (101) can be regulated by controlling the amount of current flowing to the iron (101). For this purpose, a variable resistor (106) may be interposed in the power line (105) that provides the current to the iron (101). Depending on the resistance provided by the variable resistor (106), more or less current will flow to the iron (101). As shown in FIG. 1, a dial or other user control device may be incorporated with the variable resistor (106) so that the user can control the amount of current flowing to the iron (101) and, consequently, the temperature of the iron (101).

The jig of the present invention is illustrated on the left of FIG. 1. The illustration shows the jib (100) attached to the soldering iron (101). As shown in FIG. 1, the jig (100) is a structure that supports a thermocouple clamp (102) for measuring the temperature of the soldering iron (101).

A thermocouple is a temperature sensor created by joining two dissimilar metals, such as copper and iron. A difference in potential, i.e., a small voltage, will be created at the junction of the two metals as a function of the temperature. Wires leading from the two joined metals can be monitored by an instrument (such as a voltmeter or a digital multi-meter) that measures the potential and, consequently, can determine the temperature at the junction of the coupled metals.

The jig (100) of the present invention includes a support shaft or member (108) that supports a thermocouple clamp (102). As will described in more detail below, the thermocouple clamp (102) can be clamped on the soldering iron (101). The thermocouple clamp (102) includes at least one thermocouple that is brought into contact or close proximity with the soldering iron (101) when the clamp (102) is clamped on the soldering iron (101). Wires (109) leading to the thermocouple of the clamp (102) are connected to a temperature gauge (125).

The temperature gauge (125) includes a voltage meter that measures the potential difference between the metals of the thermocouples. The temperature gauge (125) correlates this potential difference to temperature and displays a very accurate indication of the temperature of the soldering iron (101). Consequently, a technician or user can adjust the temperature of the soldering iron, if needed. The technician or user refers to the temperature reading on the temperature gauge (125) and then adjust the variable resistor (106) to increase the flow of electrical current and the temperature of the iron (101) or decrease the flow of electrical current and the temperature of the iron (101).

The support member (108) of the jig (100) also supports a guide (103). When the clamp (102) is connected to the soldering iron (101), the guide (103) is abutted against, for example, the handle (104) of the soldering iron (101). In this way, the clamp (102) is consistently clamped at the same point on the soldering iron (101) when a temperature measurement is being taken. This ensures measurements that vary with the actual temperature of the iron (101) and not the technique used to take the measurements of the iron's temperature.

While the guide (103) illustrated in FIG. 1 is designed to abut against the handle (104) of the iron (101), the guide (103) could also abut or be aligned with any other point of reference that remains constant with respect to the iron (101). It is not essential that the guide (103) abut or be aligned with any particular element of the soldering iron system. What is important is that a consistent point of reference is established using the guide so that the thermocouple clamp (102) is always placed at the same point on the iron (101) for measuring the iron's temperature.

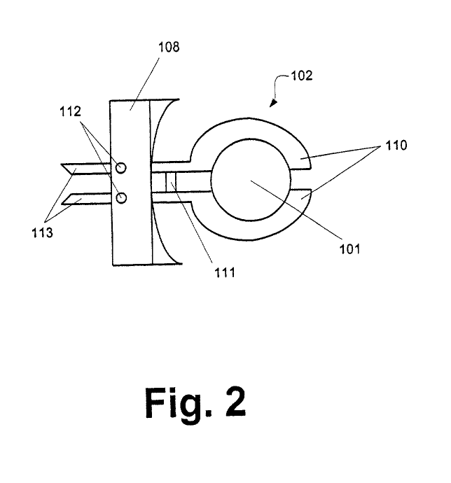

FIG. 2 illustrates an enlarged and detailed view of the thermocouple clamp (102) of the present invention. As shown in FIG. 2, the thermocouple clamp (102) is supported on the support member (108) of the jig. The thermocouple clamp (102) includes matched jaws (110) that each have a C-shape. These jaws (110) are sized to receive and hold a part of the tip of the soldering iron (101). The thermocouple of the jig may be disposed on or incorporated in the jaws (110) so as to be brought into contact or close proximity with the soldering iron (101) when a temperature measurement is being taken.

In the preferred embodiment of FIG. 2, each jaw (110) extends into a post (113). The posts (113) are each secured to a hinge or pivot point (112), preferably on the support member (108). Consequently, by moving the posts (113) toward each other and causing the posts (113) to pivot about the pivot points (112), the jaws (110) are separated to allow the soldering iron (101) to pass into and out of the jaws (110).

A spring or other biasing means (111) is preferably included to pull or push the jaws (110) together. When moving the posts (113) together, the movement is against the bias of the spring (111). When the posts (113) are released, the jaws (110) are pulled together by the spring (111) and, consequently, can clamp onto the soldering iron (101).

The spring (111) also serves another important purpose. The temperature measured by the thermocouple clamp (102) will depend on the pressure or force with which the jaws and thermocouple (110) are urged against the soldering iron (101). Using the spring (111) to provide the force that clamps the jaws (110) to the soldering iron (101), that force will always be essentially the same. Thus another variable that can affect the temperature measured is isolated and removed from consideration. Consequently, the thermocouple clamp (102) of the present invention is further enabled to provide an accurate temperature measurement that varies only with temperature and not the technique of the measurement.

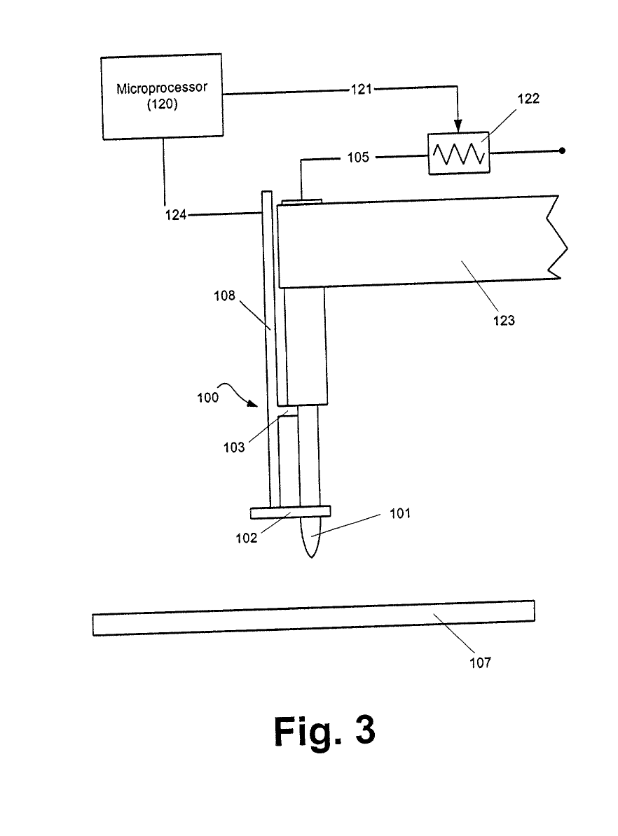

FIG. 3 illustrates a second preferred embodiment of the present invention. FIG. 3 illustrates a soldering iron (101) that has been incorporated into automated machinery for use in a high-volume production line. As noted above, it is extremely important that, in such a production operation, the soldering iron (101) be carefully monitored so as to provide consistent results and quality in the resulting products that require high-precision soldering.

As shown in FIG. 3, the soldering iron (101) has been incorporated into a robotic arm (123). This arm (123) moves the soldering iron (101) as needed to solder points during production of a product in an automated assembly line. As before, a power line (105) supplies electrical current to heat the iron (101). A variable resistor (122) is again interposed in the line (105) to regulate the current and, consequently, the temperature of the iron (101). However, this variable resistor (122) may omit the user control device, such as a dial or knob, as will be explained below.

The jig (100) is essentially identical to that illustrated and described above. Specifically, a support shaft or member (108) supports a thermocouple clamp (102) and a guide (103). Electrical lines (124) leading from the thermocouple of the clamp (102) provide input to a microprocessor (120). The microprocessor (120) may include a voltage meter or other means of determining the temperature of the iron (101) based on the output of the thermocouple clamp (102).

The microprocessor (120) is also programmed to monitor the temperature of the iron (101) using the output of the thermocouple clamp (102) and keep that temperature within a predetermined range of acceptable operating temperatures. The microprocessor (120) is also connected to the variable resistor (122) and can, through means known in the art, control the setting of the variable resistor (122) and the amount of current provided to the iron (101). Consequently, the microprocessor (120) regulates the variable resistor (122) automatically based on temperature measurements provided by the thermocouple clamp (102). In this way, the iron (101) is automatically kept at an appropriate operating temperature whenever the jig (100) is in use.

As shown in FIG. 3, the jig (100) used on the automated soldering iron (101) can be a separate unit that is applied to the iron (101) periodically or when monitoring is thought necessary. In such an embodiment, the guide (103) performs the same important function as described above with regard to a hand-held soldering iron.

Alternatively, however, as will be understood by those skilled in the art from reading this specification, the jig (100) and the thermocouple clamp (102) may be incorporated or integrated into the robotic arm (123). In such an embodiment, the jig (100) could provide constant monitoring of the temperature of the iron (101). Such constant monitoring, however, may not be necessary in a particular manufacturing application. Consequently, a jig that can be moved and used to periodically monitor different soldering irons may be a preferable and more economic solution.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A jig for monitoring a temperature of a heated instrument, said jig comprising:
a thermocouple clamp for attaching to said heated instrument to provide an indication of a temperature of said heated instrument; and
a connection for providing output to a meter that determines said temperature of said heated instrument based on output from said thermocouple clamp.

2. The jig of claim 1, further comprising a guide member that is abutted or aligned with an element of said heated instrument so that said thermocouple clamp is placed at a consistent point on said heated instrument each time said jig is used.

3. The jig of claim 2, wherein said element of said heated instrument to which said guide member is abutted or aligned is a handle of said heated instrument.

4. The jig of claim 1, wherein said heated instrument is a soldering iron and said thermocouple clamp is sized and shaped to attach to said soldering iron.

5. The jig of claim 1, wherein said thermocouple clamp further comprises:
first and second opposed clamp jaws; and
a bias element that urges said clamp jaws together so that said clamp jaws grip said heated instrument with a consistent force when said jig is applied to monitor said temperature of said heated instrument.

6. The jig of claim 5, wherein said first and second jaws extend into posts that are pivotally attached to said jig such that by moving said posts toward each other, said jaws can be moved apart against said bias element.

7. A system for monitoring a temperature of a heated instrument, said system comprising:
a jig on which is supported a thermocouple clamp for attaching to said heated instrument to provide an indication of a temperature of said heated instrument; and
a meter that is connected to and receives an output voltage from said thermocouple clamp, wherein said meter determines said temperature of said heated instrument based on output from said thermocouple clamp.

8. The system of claim 7, wherein said jig further comprises a guide member that is abutted or aligned with an element of said heated instrument so that said thermocouple clamp can be placed at a consistent point on said heated instrument each time said jig is used.

9. The system of claim 8, wherein said element of said heated instrument to which said guide member is abutted or aligned is a handle of said heated instrument.

10. The system of claim 7, wherein said heated instrument is a soldering iron and said thermocouple clamp is sized and shaped to attach to said soldering iron.

11. The system of claim 7, wherein said thermocouple clamp further comprises:
first and second opposed clamp jaws; and
a bias element that urges said clamp jaws together so that said clamp jaws grip said heated instrument with a consistent force when said jig is applied to monitor said temperature of said heated instrument.

12. The system of claim 11, wherein said first and second jaws extend into posts that are pivotally attached to said jig such that by moving said posts toward each other, said jaws can be moved apart against said bias element.

13. The system of claim 7, wherein said meter is associated with a processor which monitors said temperature of said heated instrument using said meter and automatically controls a temperature of said heated instrument in response to output of said meter and in accordance with a predetermined operating temperature range.

14. The system of claim 13, wherein said microprocessor is connected to a variable resistor for controlling electric current to said heated instrument, which heated instrument is heated by said electric current.

15. A method for monitoring a temperature of a heated instrument, said method comprising:
attaching a jig to said heated instrument using a thermocouple clamp supported on said jig, said thermocouple clamp outputting an indication of a temperature of said heated instrument; and
determining said temperature of said heated instrument based on output from said thermocouple clamp to a meter that is connected to and receives an output voltage from said thermocouple clamp.

16. The method of claim 15, further comprising abutting or aligning a guide member of said jig with an element of said heated instrument so that said thermocouple clamp is placed at a consistent point on said heated instrument each time said jig is used.

17. The method of claim 15, wherein said heated instrument is a soldering iron and said thermocouple clamp is sized and shaped to attach to said soldering iron.

18. The method of claim 15, wherein said thermocouple clamp further comprises first and second opposed clamp jaws, and a bias element that urges said clamp jaws together so that said clamp jaws grip said heated instrument with a consistent force when said jig is applied to monitor said temperature of said heated instrument; and
wherein said attaching said jig to said heated instrument further comprises griping said heated instrument with said first and second clamp jaws of said thermocouple clamp.

19. The method of claim 18, wherein said attaching a jig to said heated instrument further comprises moving posts toward each other to move apart said clamp jaws to receive said heated element, wherein said posts extend from said first and second jaws and are pivotally attached to said jig such that by moving said posts toward each other, said jaws can be moved apart against said bias element.

20. The method of claim 15, further comprising automatically controlling a temperature of said heated instrument in response to output of said meter and in accordance with a predetermined operating temperature range.

21. A jig for monitoring a temperature of a heated instrument, said jig comprising:
first means for attaching said jig to said heated instrument;
second means for providing an indication of a temperature of said heated instrument; and
third means for determining said temperature of said heated instrument based on output from said second means.
